(19) United States
(12) Patent Application Publication
(10) Pub. No.: US 2015/0344758 A1
(43) Pub. Date: Dec. 3, 2015

(54) ABRASIVE GRAIN WITH CONTROLLED ASPECT RATIO AND THICKNESS

(71) Applicant: Shengguo WANG, Shanghai (CN)

(72) Inventor: Shengguo WANG, Shanghai (CN)

(21) Appl. No.: 14/821,274

(22) Filed: Aug. 7, 2015

Related U.S. Application Data
(63) Continuation-in-part of application No. PCT/CN2013/071601, filed on Feb. 13, 2013.

(51) Int. Cl. C09K 3/14

(52) U.S. Cl. CPC C09K 3/1409

(57) ABSTRACT

A sintered sol gel alumina abrasive's aspect ratio and thickness is controlled by drying the gel on a PTFE belt with punched holes. This abrasive material has high abrasive performance and its manufacturing cost is reduced, compared to conventional sol gel abrasive grains.

### FIELD OF TECHNOLOGY

The invention relates to a novel process to control the aspect ratio and thickness of sol gel alumina abrasive grain and reduce the manufacturing cost of the sol gel process by improving the yield of useful grit size.

### DESCRIPTION OF RELATED ARTS

A major focus in the abrasive industry today is the development of more efficient abrasive grain having high cut rate and longer service life for both light and high pressure grinding applications.

As known to us, the present alumina abrasive grains include fused abrasive grain such as brown fused alumina, white fused alumina, mono crystal alumina and semi-friable alumina and sintered abrasive grain such as sol gel abrasive. Fused alumina abrasive is melted in tilting furnace and poured into ingots of sizes suitable for the desired rate of cooling and resulting crystal size. Because of its low cost due to mass production and cheap raw material, fused alumina abrasive is widely used in coated and bonded abrasive, but its grinding performance including cut rate and total cut or grinding ratio is limited.

Since the early 1980's, sol-gel technology has been used to improve the performance of alumina abrasive and has had a major impact on both the coated and bonded abrasive business. Sol-gel processing permits the microstructure of the alumina to be controlled to a much greater extent than is possible by the fusion process. Consequently, the sol-gel abrasive has a crystal size several orders of magnitude smaller than that of the fused abrasive and exhibit a corresponding increase in toughness and abrasive performance.

During the last several decades, many efforts are put on how to increase the grinding performance of sol-gel abrasive grain. These efforts include exploring additives such as modifiers and sintering aids, seeds and optimizing manufacturing process such as shaping and sintering techniques. One of the key findings of these efforts is to get sharp abrasive grains by improve the aspect ratio of grain to increase the grinding performance; in other words, to decrease the packing density of abrasive grain.

U.S. Pat. No. 4,848,041 describes a sol-gel abrasive grain having the shape of a thin platelet, the average thickness of which must be no more than about 460 micrometers. The products made with the grains of this invention exhibit higher initial cut and higher total cut, along with lower grinding force than do products having equivalent weight loadings of conventional abrasive grains. But the aspect ratio of this invention is still not satisfactory, the average aspect ratio of the grain is less than 1.7 and the manufacturing step still included crushing step and some fine grits would be produced in this step. As known to the industry, the fine grits of sol-gel abrasive has no obvious advantage over fused abrasive when the grit size is smaller than P120 or F120. So these fine grits has to be recycled or disposed, which would increase the manufacturing cost.

U.S. Pat. No. 5,090,968 describe a device and process for producing filamentary abrasive particles having substantially equal ratios without further length reduction. The filamentary abrasive grain has controlled shape (cross section is round) and aspect ratio, but the physical size of abrasive grain is only controlled by 2 dimensions: length and diameter. In our invention, the shape of abrasive grain is not filament (cross section is round), it's rectangular or pentagon, similar to conventionally crushed sharp edged abrasive grain. The most important innovation of this invention, compared with U.S. Pat. No. 5,090,968 is that we can control 3 dimensions of abrasive grain: length, width and thickness. Aspect ratio of abrasive grain is only the ratio of length to width (or length to diameter for filamentary abrasive grain), thickness of abrasive grain is also the critical parameter to control the grinding performance, as described in US 2009/0307985 A1. In our invention, we can easily change the thickness of rectangular or pentagon abrasive grain to meet different grinding requirements.

U.S. Pat. No. 7,169,198 describes a method for the production of a sintered, microcrystalline alpha alumina based shaped body, which are used as abrasive bodies, wherein an alpha alumina powder is used as starting material, said powder having an average particle diameter below 2 micrometers; and pressed with at least one binder and a solvent with the purpose of obtaining an extrudable material that is subsequently extruded. The extrudate is then further pressed into a shaped body that is sintered at a temperature range of between 1300° C. and 1750° C. However, the size of the extruded abrasive grain is relatively large, several millimetres long. It's very difficult for electro-static coating for coated abrasive products.

U.S. Pat. No. 6,083,622 describe a process to make very sharp sol-gel abrasive grain. Sol-gel alumina that is dried but unfired can be explosively communicated by feeding the dried gel into a furnace held at a temperature above those at which vaporizable materials are eliminated from the particle of gel. At suitable elevated temperatures the firing is sufficient to form fully densified alpha alumina particles of a size suitable for direct use as abrasive grits. The grains with aspect ratio L/D≧2.0 in this kind of fired abrasive is high, from 27˜54% in its examples, but not all grits have L/D higher than 2.0. and this process had a major drawback: this process did not have calcining step, the dried material is directly fed into the furnace with temperature higher than 1000° C. The dried material is “explosively communicated”, some fine and unusable grits are produced and the yield of usable grits is reduced, so the total cost of the grain is increased to some extent.

US 2009/0307985 A1 described a method for producing and using very low packing density/high aspect ratio ceramic abrasive grits including various fused alumina materials or sintered sol gel alumina materials. Ribbons of sol gel were extruded into various thickness, dried, crushed, calcined at 650° C. and sintered at 1370° C. The resulted sol gel abrasive has packing density from 1.33 to 1.70, much sharper than conventional abrasive grains. But the process also included crushing step, some unusable grits are produced inevitably.

U.S. Pat. No. 6,054,093 described that shaped ceramic material can be obtained by screen printing the desired shapes from a dimensionally stable dispersion of a precursor of the ceramic onto a surface, drying the screen printed shapes so obtained and firing them to generate the shaped ceramic article. The abrasive grain's aspect ratio of L/D can be controlled, but their claimed aspect ratio is from 2:1 to about 50:1. As is known to all in coated abrasive industry, if the aspect ratio of abrasive grain is too high, for example, higher than 2.5, it needs more size or supersize coating weights to hold the abrasive grain, not practical for economical coated abrasive's production. In U.S. Pat. No. 6,054,093, thickness of abrasive grain is not considered either, while the abrasive grain's thickness is also a critical parameter to control grinding performance.

So, there is a need to improve the sol gel abrasive manufacturing process to control aspect ratio & thickness and improve the yield of usable abrasive grains.

### SUMMARY OF THE INVENTION

It is an object of the invention to provide a method of economically producing sol gel abrasive material which has controlled aspect & thickness. The manufacturing process of this invention includes the following steps:

(1) Dispersion preparation: Sol dispersion is prepared by mixing deionized water, highly dispersed alumina monohydrate, nitric acid, submicron-sized alumina seeds and other additives to modify sintering or microstructure. The mixing equipment can be high shear mixer or ball mill. The solid content of the dispersion is preferably from 25%˜30%. The prepared dispersion is further dried to 40˜50% solid content gel for further aspect ratio control process.

(2) Molding and Drying: The aspect ratio of sol gel abrasive is controlled in this process. A PTFE film web with punched holes is shown as in FIG. 1; it functions as an aspect ratio control mold and carrier belt for drying. The gel prepared in step (1) is pressed into the holes by knife on roll coating method as shown in FIG. 2. After being process into the holes, the gel is further drying in a forced air drying oven. The drying time and temperature are varied for different thickness and products.

(3) Calcining: The dried gel is then further calcined in a rotatory furnace to remove the residue water and some volatiles. The preferred calcining temperature is from 500˜850° C. and the preferred calcining time is from 10˜60 minutes.

(4) Sintering: The calcined particle is then fed into a SiC rotatory furnace for sintering to densify the particles. The preferred sintering temperature is from 1300˜1500° C. and the preferred sintering time is from 5˜120 minutes.

### BRIEF DESCRIPTION OF THE DRAWINGS

FIG. 1 is a PTFE belt with punched holes to make abrasive grain with controlled L/D and thickness.

FIG. 2 is a PTFE belt with punched holes to make abrasive grain with a shape like Roman dagger tip.

FIG. 3 is a device to make abrasive grain with controlled aspect ratio and thickness.

### DETAILED DESCRIPTION OF THE PREFERRED EMBODIMENT

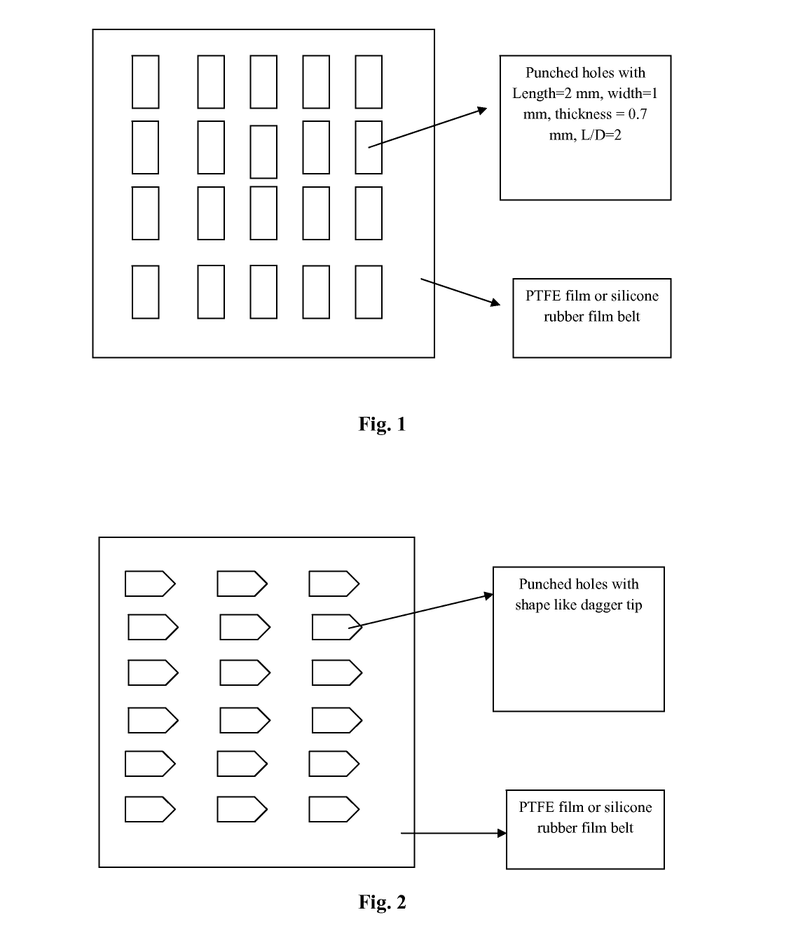

From the drawing shown as FIG. 1, the aspect ratio & thickness of abrasive grain can be easily controlled by changing the length, width and thickness of punched holes of the PTFE film belt. Also the girt size is also able to be easily controlled by the width and thickness of the punched holes, so no fine grits that are unusable will be produced and the yield of usable grits is very high, compared crushed sol gel abrasive gains.

So, using this kind of molds, we can easily get abrasive grains with aspect ratio L/D=1-2, and crushing step is eliminated. For different applications, grains with different aspect ratios are required, for example, grinding wheel prefer cubic abrasive grit, which can be made by PTFE film belt with punched holes whose length=width=thickness. Coated abrasive belt prefer abrasive grain with high aspect ratio. We controlled the aspect ratio L/D=1 for bonded abrasive applications and 1.5-2 for coated abrasive applications. Aspect ratio higher than 2 is not good for practical and economic coated abrasive applications because it needs more size or supersize coating weights to hold the long abrasive grain.

For low pressure grinding applications, abrasive grain having high aspect ratio have high cut rate and long service life; while in some high pressure grinding applications, the long abrasive grain tends to be fractured and the grinding performance is weakened. But this drawback could be improved by blending sol gel abrasive having high aspect ratio with conventional crushed fused abrasive such as brown alumina, mono crystal alumina and semi-friable alumina. These short abrasive grains can support the long sol gel abrasive in high pressure grinding applications.

For low pressure grinding applications such as paper backing or flexible cloth backing products, some special shaped abrasive grain can be tailed for these applications; the shape of this abrasive grain is just like Roman dagger tip. The PTFE film belt for making this shape of abrasive grit is shown in FIG. 2.

Detailed description of this invention is shown in the following examples.

### Example 1

A high shear mixer was charged with 30% boehmite, 1.4% nitric acid with 65% concentration and 69.6% deionized water, then mixed for 10 minutes under vacuum, then 1% alumina seed (average particle size=0.1 micrometer) with respect to final sintered alpha alumina content and some amount of rare earth oxide including Y₂O₃, La₂O₃, Nd₂O₃ and MgO in the form of nitrate salts are added and mixed for 10 minutes under vacuum.

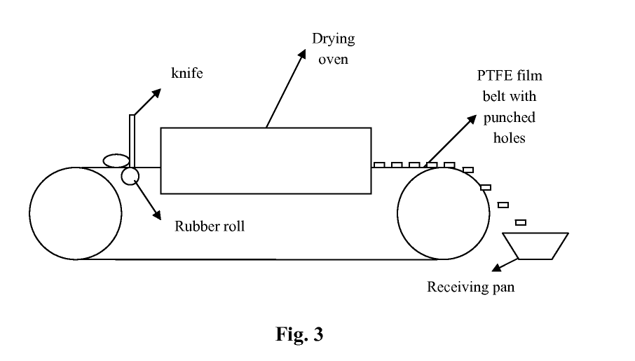

The resulted gel was then dried to 45% solid gel and was pressed into the punched holes on PTFE film belt using knife coat on roll method shown as in FIG. 3. The dimension of the punched holes is as follows: length=2 mm, width=1 mm and thickness=0.7 mm.

The PTFE belt then entered into a forced air drying oven with a temperature from 120˜130° C. and was dried for 20 minutes. The dried particle was removed from the belt after getting out of drying oven and was received in a pan. Then the dried particles were fed into a stainless steel rotary tube furnace for calcining The calcining temperature is 700° C. and the calcning time is 20 minutes. The calcined particle was then fed into a SiC tube rotary tube furnace for sintering. The sintering temperature is 1400° C. and the sintering time is 7 minutes. The sintered abrasive grit has an aspect ratio about 2. The Vickers hardness at 500 grams load is about 20 GPa.

### Example 2

The abrasive grain prepared in example 1 was made into an abrasive belt. The backing was a 560 grams/square meter treated polyester cloth with tensile strength at break=3500 N/50 mm and elongation at 600 N=0.8%. The coating weights are as follows and gsm stands for grams/square meter:

Dry make weight: 300 gsm, CaCO3 filled phenolic;

Abrasive grit: 400 gsm P36 semi-friable alumina blended with 500 gsm sol gel abrasive grain in example 1;

Dry size weight: 400 grams/square meter, cryolie filled phenolic;

Supersize weight: 400 grams/square meter, conventional formulation

The belt was tested on a backstand grinder, the test conditions are as follows:

Workpiece: 304 staniless steel;

Belt speed: 30 meters/second;

Pressure: 4 kg/square centimeters.

Test cycle: 1 minute grinding time

The grinding test was ended when the cut rate became below ½ of the 1^{st} minute cut rate. The control belt is commercially available alumina zirconia belt made from Saint Gobain's NZ Plus grit. The total cut of the invented sol gel abrasive belt is about 140% of the control belt.

1. A method to produce sol gel abrasive particles with controlled aspect ratio and thickness, characterized in that, it uses a PTFE film belt with punched holes, the hole has a rectangular shape, or pentagon shape like Roman dagger tip, the length, width and thickness of which are in the range of 0.5˜3 mm, the preferred aspect ratio L/D is in the range of 1-2 and thickness/width is in the range of 0.2-1.0.

2. An abrasive grain, characterized in that, it is made by the method according to claim 1 and its raw material is a submicron alpha alumina dispersion with solid content from 65˜80%.

3. A coated abrasive product, characterized in that, it is made by the method according to claim 1.

4. A bonded abrasive product, characterized in that, it is made by the method according to claim 1.
